(19) United States
(12) Patent Application Publication
(10) Pub. No.: US 2026/0116441 A1
(43) Pub. Date: Apr. 30, 2026

(54) LOCOMOTIVE FLEET ASSIGNMENT SYSTEM

(71) Applicant: PROGRESS RAIL LOCOMOTIVE INC., LAGRANGE, IL (US)

(72) Inventors: Rodrigo Almeida Goncalves, Campinas (BR); Alexandre Tazoniero, Curitiba (BR); Sammy Akif, Northlake, TX (US); Colby Smith Bradley, Atlanta, GA (US); Fernando Antonio Campos Gomide, Campinas SP (BR); Thiago Cantos Lopes, Curitiba (BR)

(21) Appl. No.: 18/929,265

(22) Filed: Oct. 28, 2024

(51) Int. Cl. B61L 27/16

(52) U.S. Cl. CPC B61L 27/16; B61L 2201/02

(57) ABSTRACT

A system and method for locomotive assignments and scheduling is described herein. The system provides for receiving railroad information related to a railroad system including locomotives within the railroad system, determining railroad data from the railroad information by processing the railroad information, the railroad data associated with schedules, conditions, demand of locomotives, and availability of locomotives, determining a set of rules for assigning locomotives to trains, locations, and maintenance, the set of rules determined by a machine learning model trained using historical railroad data tagged with locomotive assignment information, determining assignments for locomotives within the railroad system using the set of rules in response to the railroad data, and outputting the assignments and executing the assignments of the locomotives.

### TECHNICAL FIELD

The present application generally relates to managing a railway system, and more particularly, to consolidating and processing data related to the status of the railway environment and generating commands and operating instructions for locomotives across the railway system.

### BACKGROUND

A railway and the train fleet that may operate on it are typically managed, assigned, and controlled based on current and expected desired cargo and locomotive movement. In other words, assignments for each locomotive of the train fleet may be determined or produced based on the available resources of both the railway and train fleet to attempt to satisfy the existing and expected cargo movement orders and demands. In some instances, each locomotive of the train fleet may be issued an assignment which may incorporate information relating to the cargo, end destination, route selection, and timing information for the next stop for each locomotive. To accurately determine assignments across an entire train fleet, a basis or understanding of the existing status of the train fleet, railway, surrounding environment, and existing demand must be created. Presently, consolidating data and determining assignments for the railway system is done manually, resulting in an arduous and time-consuming process due to the large number of static and dynamic factors that may be associated with the train fleet, railway, surrounding environment, and existing demand. For example, a review of the information may take into account dynamic information that may be unpredictable, such as running times between legs of track or railyards, changing train schedules, changing crew availability, delays related to unexpected stops or repairs, inclement weather, or a change in the overall demand of the train fleet due to the addition, amendment, or cancellation of orders.

Current solutions rely on a user manually collecting or receiving each piece of information related to the train fleet, railway, surrounding environment, and existing demand each day before the user may begin determining assignments for the components of the train fleet. Furthermore, due to the manual nature of the process, there inherently exists inconsistency between each user due to their experience level, training, and personal biases that may come in account when consolidating each piece of information. Therefore, there is an interest in developing a system or method which may be more efficient and responsive to changes in status of the railway or train fleet while also providing a more uniform or consistent consolidated basis.

Some efforts have been made to use automatic processes for optimizing assignments for a train fleet within a railway. For example, US Publication No. 2019/0130515A1 to Amos (“the '515 patent”) describes an autonomous scheduling system for improving transportation planning and allocation of resources that may be responsive to input from a passenger interface. The '515 patent specifically uses the interface to provide a passenger with an opportunity to input changes or requirements into the autonomous model, which may affect the output scheduling result. Information such as acceptable delays, timing of arrival and departure, preferred types of transportation etc., may all be input and considered by the autonomous system. However, the system and method described in '515 does not include details or features directed towards continuously updating or training a model based on the user input. In particular, '515 merely provides for a user to set parameters or variable for the autonomous system to incorporate in the calculations. Furthermore, the '515 patent fails to discuss how the autonomous system may be used to generate or consolidate the broad quantity of dynamic information which may be collected and associated with a train fleet and railway and how the autonomous system may adjust the schedule based on experienced changes.

### SUMMARY

In examples, the systems and techniques described herein may provide a system for determining locomotive assignments within a railroad system, for example to assign locomotives to train consists, rail yards, maintenance yards, and other such allocations. The system includes a processor and a non-transitory computer readable medium that stores instructions that when executed by the processor causes the processor to perform various operations. The operations include receiving railroad information related to a railroad system including locomotives within the railroad system and determining railroad data from the railroad information by processing the railroad information, the railroad data associated with schedules, conditions, demand of locomotives, and availability of locomotives. The operations further include determining a set of rules for assigning locomotives to trains, locations, and maintenance, the set of rules determined by a machine learning model trained using historical railroad data tagged with locomotive assignment information. The operations also include determining assignments for locomotives within the railroad system using the set of rules in response to the railroad data and outputting the assignments and executing the assignments of the locomotives.

Implementations of the system may include one or more of the following features. Outputting the assignments and executing the assignments may include preparing at least one command for at least one locomotive, where the command is based on the assignments and transmitting the at least one command to a railyard associated with the at least one locomotive. Receiving the railroad information may include accessing one or more messages conveyed by computing devices of the railroad system and determining the railroad data further may include processing the messages using a large language model. The operations further include displaying the assignments on an output device, receiving an indication inputted into an input device by a user, the indication associated with an adjustment to one or more of the assignments, determining one or more additional rules using the machine learning model, and determining a second set of assignments using the set of rules and the one or more additional rules. The railroad information may include, information related to a position and status of the locomotives, information related to a condition of the railroad system, and information related to a demand for locomotives within the railroad system. The set of rules describe conditions for locomotive assignments and determining the assignments may include applying the set of rules to the railroad data. The railroad information further may include locomotive maintenance schedules for locomotives in the railroad system. Implementations of the described techniques may include hardware, a method or process, or computer software on a computer-accessible medium.

In an illustrative example, one general aspect includes a computer-implemented method for determining locomotive assignments. The computer-implemented method includes receiving railroad information related to a railroad system including locomotives within the railroad system and determining railroad data from the railroad information by processing the railroad information, the railroad data associated with schedules, conditions, demand of locomotives, and availability of locomotives. The method also includes determining a set of rules for assigning locomotives to trains, locations, and maintenance, the set of rules determined by a machine learning model trained using historical railroad data tagged with locomotive assignment information. The method further includes determining assignments for locomotives within the railroad system using the set of rules in response to the railroad data. The method also includes outputting the assignments and executing the assignments of the locomotives.

Implementations may include one or more of the following features. Determining the assignments may include using a second machine learning model configured to produce the assignments in response to the railroad data and the set of rules, where the second machine learning model is trained using historical locomotive assignment data, historical rule data, and one or more evaluation parameters. The computer-implemented method may include receiving one or more additional conditions for assigning the locomotives, and determining, using the machine learning model, a second set of rules based on inputs of the set of rules and the one or more additional conditions. Outputting the assignments and executing the assignments may include preparing at least one command for at least one locomotive, where the command is based on the assignments, and transmitting the at least one command to a railyard associated with the at least one locomotive. The computer-implemented method may further include displaying the assignments on an output device; receiving an indication inputted into an input device by a user, the indication associated with an adjustment to one or more of the assignments, determining one or more additional rules using the machine learning model, and determining a second set of assignments using the set of rules and the one or more additional rules. The set of rules may describe conditions for locomotive assignments and determining the assignments may include applying the set of rules to the railroad data. The set of rules are further provided to the machine learning model as inputs. Implementations of the described techniques may include hardware, a method or process, or computer software on a computer-accessible medium.

### BRIEF DESCRIPTION OF DRAWINGS

The accompanying drawings, which are incorporated in and constitute part of this specification, illustrate various exemplary embodiments and, together with the detailed description, serve to explain the principles of the disclosed embodiments. Wherever possible, the same reference numbers will be used throughout the drawings to refer to the same or like parts.

FIG. 1 is a schematic diagram of an exemplary system and a method for generating locomotive assignments, in accordance with one or more examples.

FIG. 2 illustrates a system architecture for generating locomotive assignments across a fleet of a railroad system, in accordance with one or more examples.

FIG. 3 illustrates a fleet manager used for generating locomotive assignments, in accordance with one or more examples.

FIG. 4 illustrates a method for generating locomotive assignments, in accordance with one or more examples.

FIG. 5 illustrates depicts a component level view of a controller for use with the systems and methods described herein, in accordance with one or more examples.

### DETAILED DESCRIPTION

Locomotive scheduling or locomotive assignment is presently an extremely complex and time-consuming process. Using typical systems, operators may have to use significant time to sift through information to determine a current state of a railroad system. After determining the current state, there is often an imbalance between the resources available (e.g., locomotives available) and the demand required. For example, there may be significantly more tonnage moving towards the coasts than going to a region at or near the Midwest of the United States, resulting in a very scenario where the fleet managers spend significant time and resources to ensure that the locomotives end up where they need to go to continue moving the train consists as scheduled.

The systems and methods described herein provide for determining locomotive assignments including assignments to train consists, assignments to maintenance locations, re-balancing locomotive quantities by moving locomotives through “dead-heading” locomotives from one rail yard to another. To accomplish the locomotive assignment, the systems and methods described herein provide for preprocessing of data, in particular preprocessing railroad system data into a knowledge database that stores local knowledge, rules, changing situations, etc. for the locomotives in the railroad system. The knowledge database may include knowledge from a fleet manager as well as from other sources of data and compiles it in a single repository. The knowledge database may be populated based on entries of information by a fleet manager, accessing data sources, and using one or more natural language processing algorithms, such as a large language model (LLM) to translate natural language from messages or inputs from the fleet managers and other devices and sources and outputs data for storage at the knowledge database. The LLM may be used to determine counts and locations of locomotives including locations for locomotives and may also be used to add trains, add locomotives (e.g., returning in the near future from a maintenance stop), and/or change schedules for trains, locomotives, or maintenance. The knowledge database may serve as a collection of data over time and may be built using sources of data over time to further refine and improve the information stored within the knowledge database. A data processing engine may take inputs from the knowledge database, railroad data, and other sources of data associated states and conditions of the railroad system and/or an environment including the railroad system. The data processing engine and knowledge database may both use the LLM to crawl through messages and other data to identify information relevant to the railroad system. The data processing engine may receive the data sources and/or natural language data and may be used to generate one or more rules and/or items of information to store in the knowledge database.

The systems and methods herein provide for receiving the processed data, e.g., the data from the knowledge database as well as the railroad data to determine assignments of locomotives across the railroad system. The rules from the knowledge database and the railroad data are used to determine the assignments, for example by using the present state information of the railroad data as well as future information for the railroad system including sequences of multiple assignments for locomotives. The assignments may be provided through a user interface and may be revised through various inputs. The revisions may be used to generate one or more further rules for storing in the knowledge database and iteratively or subsequently determining new assignments for the locomotives.

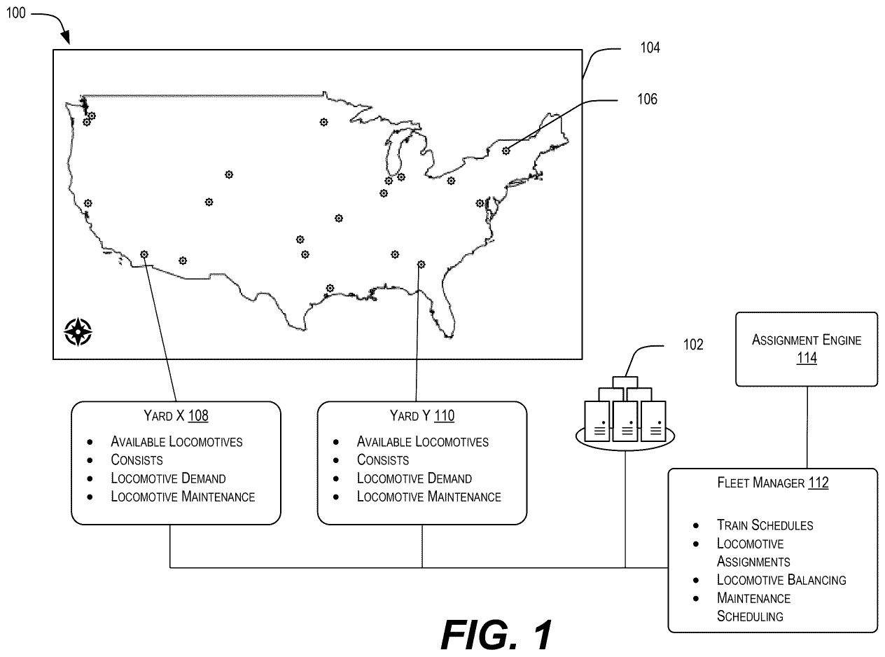

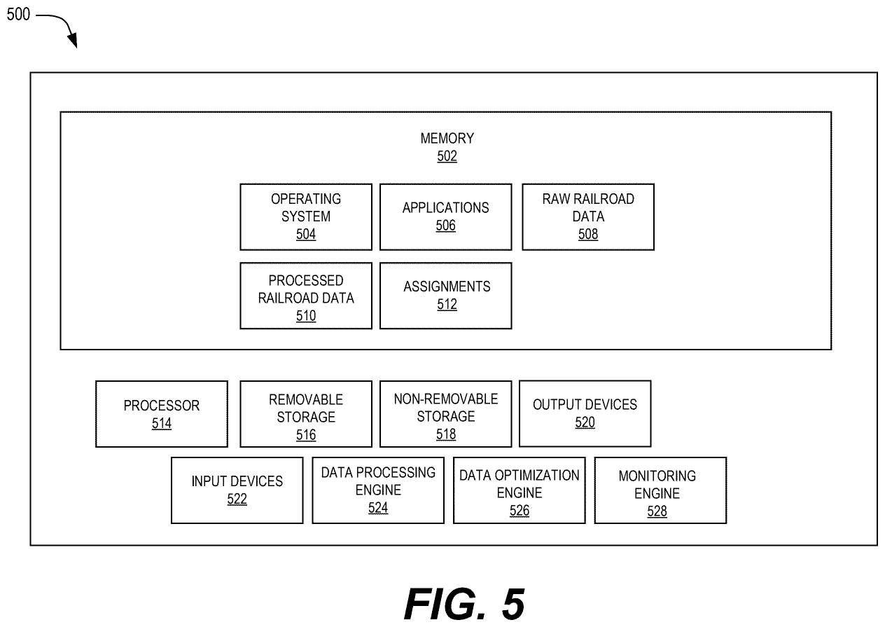

Referring now to the figures, FIG. 1 is a schematic diagram of a system 100 for generating locomotive assignments, in accordance with one or more examples. The system 100 includes a computing device 102 such as a server computer, or other computing system, such as described herein with respect to FIG. 5. The computing device 102 may include a server, cloud-based computing system, or other such computing device that hosts one or more services, for example to host and manage a railroad system.

The system 100 is shown illustrating a user interface 104 representing a map including yards 106 shown across a geographic region. The yards 106 may include a series of yards 106 serviced or owned by a particular fleet owner or manager. The yards 106 may include locations where train consists are assembled using locomotives and train cars. The yards 106 include yard X 108 and yard Y 110. The yards 106, including yard X 108 and yard Y 110, have data associated with them describing information such as available locomotives, train consists, locomotive demand, locomotive maintenance, and other such information.

A fleet manager 112 of the computing device 102 may be used to manage train schedules across the railroad system, manage locomotive assignments, perform locomotive balancing across the fleet, and manage maintenance scheduling. The fleet manager 112 may include one or more modules or engines for performing particular tasks, such as an assignment engine 114 to perform locomotive assignments including scheduling, rebalancing, and association with train consists.

In an example, the assignment engine 114 determines locomotive assignments including assignments to train consists, assignments to maintenance locations, re-balancing locomotive quantities by moving locomotives through “dead-heading” locomotives from one yard 106 to another. To accomplish the locomotive assignment, the assignment engine 114 may preprocessing data into a knowledge database that stores one or more rules for assigning the locomotives in the railroad system. The rules may be derived from knowledge from a fleet manager as well as from other sources of data and be compiled into a repository. For instance, in the example, the assignment engine 114 may determine the rules for assignments based on entries of information by a fleet manager, accessing data sources, historical data, use of one or more trained machine learning models, and using one or more natural language processing algorithms, such as a large language model (LLM) to translate natural language from messages or inputs from the fleet managers and other devices and sources and outputs data for storage at the knowledge database.

In the example, the LLM and/or the machine learning model may be used to determine counts and locations of locomotives including locations for locomotives and may also be used to add trains, add locomotives (e.g., returning in the near future from a maintenance stop), and/or change schedules for trains, locomotives, or maintenance. The machine learning model of the assignment engine 114 may be used to receive the data from the knowledge database and determine rules for determining assignments of locomotives based on current conditions and states of the railroad system. The knowledge database may serve as a collection of data over time and may be built using sources of data over time to further refine and improve the information stored within the knowledge database. A data processing engine, that may include a machine learning model, may take inputs from the knowledge database, railroad data, and other sources of data associated states and conditions of the railroad system and/or an environment including the railroad system.

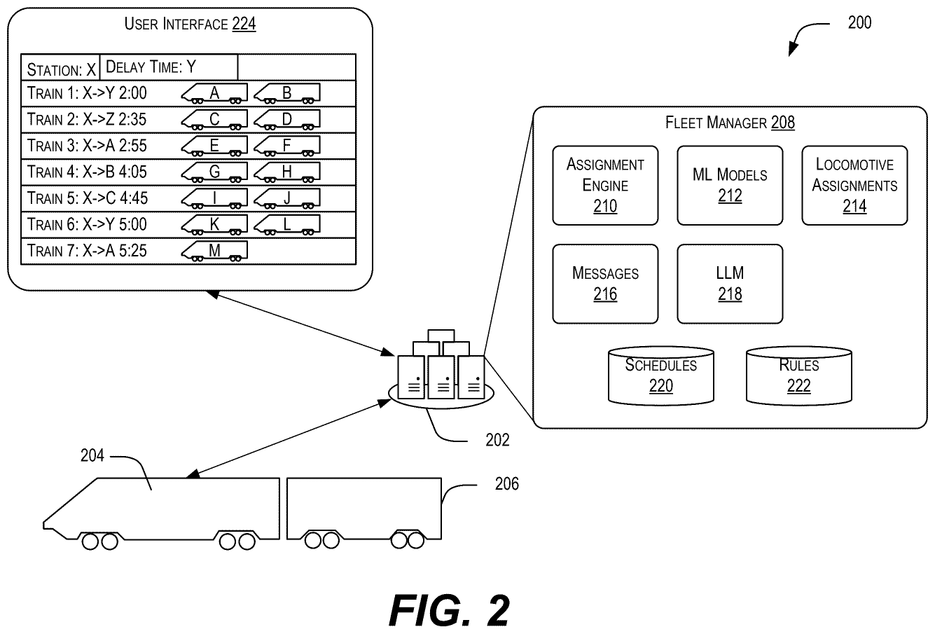

The assignment engine 114 provides for receiving the processed data, e.g., the data from the knowledge database as well as the railroad data to determine assignments of locomotives across the railroad system, such as across yards 106. The rules from the knowledge database and the railroad data are used to determine the locomotive assignments, for example by using the present state information of the railroad data as well as future information for the railroad system including sequences of multiple assignments for locomotives. The assignments may be provided through a user interface (e.g., as shown in FIG. 2) and may be revised through various inputs. The revisions may be used to generate one or more further rules for storing in the knowledge database and iteratively or subsequently determining new assignments for the locomotives.

FIG. 2 illustrates a system architecture 200 for generating locomotive assignments across a fleet of a railroad system, in accordance with one or more examples. The system architecture 200 includes a computing system 202 that is in communication with a train fleet including locomotives 204 and consists 206. The train fleet may include a plurality of sensors configured to collect information relating sufficiently and accurately to the status, operation, location, navigation, and other information related to each individual locomotive and train consist of the train fleet, including both the locomotive 204 and the train consists 206. Furthermore, information or data related to the track on which the train fleet travels, weather surrounding the track, or other related information may additionally be collected. The computing system 202 may be configured to receive, organize, and disperse information to the train fleet, the railways under operation, status of current demand and orders, and the environment surrounding the railways (i.e., weather, delays, rail conditions, availability of locomotives, existing train schedules, running times between yards, crew schedules, potential delays, etc.). Generally, once collected, said information may be transferred to the computing system 202 via a wireless or wired method known in the art such as, but not limited to, WIFI, Bluetooth, cellular networks, or satellite communication. Alternatively, data collected by the train fleet may be transferred in a traditional wired method as well, for example, when an individual train of the train fleet arrives at a destination.

Computer system 202 may be described in detail and with additional components and structure in FIG. 5. The computing system 202 includes a fleet manager 208 that may act as a central controller for the train fleet. Generally, the computer system 202 may be configured to receive and organize the information gathered or received by the fleet manager 208, determine assignments for each locomotive of the fleet, and transmit commands to the overall train fleet relating to each assignment. Each assignment or command may incorporate information related to the desired destination, time of departure, expected cargo, and route for each locomotive of the train fleet. In particular, the computer system 202 may be configured to autonomously, or semi-autonomously via user inputs, assess the current environment of the train fleet, railway in operation, environment surrounding said railway train fleet, and existing and expected future demands to generate commands or assignments for each locomotive of the train fleet.

The fleet manager includes an assignment engine 210 which may be similar to the assignment engine 114 of FIG. 1. The fleet manager 208 also includes machine learning models (ML models 212), locomotive assignments 214, messages 216, a large language model (LLM 218), as well as data repositories relating to schedules 220 and rules 222 that may include information such as stored in the knowledge base referred to herein.

The fleet manager 208, and in particular the assignment engine 210 is used to determine assignments and commands for the locomotives of the train fleet, the fleet manager 208 initially collecting or receiving data related to the train fleet as discussed herein. As noted above, the fleet manager 208 is configured to compile or collect each piece of data which collectively may be called the raw railroad data. The raw railroad information may be consolidated and presented to a user via a user interface. A previous process of consolidating the raw railroad information may be an arduous and time-consuming process due to the large number of variables and the dynamic nature of the railway system. For example, a review of the information may take into account present data such as the position of each locomotive, the availability of each locomotive, existing scheduling and demands of each locomotive, the status of each locomotive (i.e., under repair) and the availability of crew. In addition, more unpredictable or dynamic variable may be considered, such as running times between legs of track or railyards, changing train schedules, changing crew availability, delays related to unexpected stops or repairs, inclement weather, or a change in the overall dem and of the train fleet due to the addition, amendment, or cancellation of orders. Furthermore, the present consolidation process is quite varied and inconsistent as a user's knowledge, training, personal bias, and experiences may vary how they interpret the information, potentially leading to inconsistent assignments between the users.

The fleet manager 208, and in particular the assignment engine 210 consolidates the information as collected to then process the information using rules 222 to provide an assignment for each locomotive of the rail system. In further detail, the fleet manager 208 may incorporate an algorithm such as ML models 212, a neural network, a table, a linear model, a non-linear model, a deep neural network, or other methods known in the art. In some instances, the algorithm may take the form of an inference engine (or multiple inference engines) which may be used by the computer system 202 and the fleet manager 208 to process the raw information to estimate a realistic basis or cumulative status of resource availability and demand for locomotives.

The fleet manager 208 may include a knowledge database that may be used in conjunction with the assignment engine 210 to assist with the interpretation and consolidation of the raw information. To explain further, the knowledge database may include a set of rules 222 and/or an algorithm such as a machine learning model or knowledge-based artificial intelligence agent configured to provide the assignment engine 210 with argumentative knowledge, rules, and structure for determining locomotive assignments based on the consolidated the raw data gathered by the computer system 202.

Once the raw railroad information is consolidated via the fleet manager 208, the data may be provided to the user via the user interface. The user interface may be configured to be included within the computer system 202 or may be a separate component in communication with the computer system 202.

The consolidation of the raw railroad data may include processing of messages 216 by the LLM, as discussed herein. In particular, the knowledge database (including the rules 222) may be populated based on entries of information by a fleet manager 208, accessing data sources, and using one or more natural language processing algorithms, such as a large language model (LLM 218) to translate natural language from messages 216 or other inputs from the fleet managers and other devices and sources and outputs data for storage at the knowledge database. The LLM 218 may be used to determine counts and locations of locomotives including locations for locomotives and may also be used to add trains, add locomotives (e.g., returning in the near future from a maintenance stop), and/or change schedules for trains, locomotives, or maintenance. The rules 222 (sometimes referred to as the knowledge database) may serve as a collection of data over time and may be built using sources of data over time to further refine and improve the information stored within the knowledge database. The assignment engine 210 may take inputs from the locomotive assignments 214 relating to current assignments, schedules 220, and rules 222, as well as railroad data, and other sources of data associated states and conditions of the railroad system and/or an environment including the railroad system and output new locomotive assignments 214 for present and/or future conditions within the rail system.

The assignment engine 210 may then produce a plurality of assignments for the train fleet based on the processed railroad data and using the rules 222 (e.g., the knowledge database). The computer system 202 may incorporate one or more components of the fleet manager 208 including the assignment engine 210, ML models 212, and other such components to assess the processed railway information and provide a plurality of locomotive assignments 214. Each locomotive assignment 214 may incorporate information related to the desired destination, time of departure, expected cargo, and route for each locomotive of the train fleet. In some instances, the assignment engine and/or knowledge database may incorporate an algorithm such as a machine learning model, a neural network, table, linear model, non-linear model, deep neural networks, or other methods known in the art to optimize a flow of resources or commodities through a dynamic network.

In examples, the locomotive assignments 214 may be displayed on a user interface 224 that includes information relating to various train consists across the rail system and/or at a particular station. The user interface 224 also includes assignments of locomotives to various train consists, whether each locomotive is in service, in maintenance, being transported (e.g., dead-heading), and other such information. The user interface 224 may also reflect an anticipated delay time for the fleet of trains based on the assignments, which may be determined by the assignment engine 210 as part of determining the locomotive assignments 214. The delay may be a factor that the assignment engine 210 is configured to minimize and/or reduce across the entire fleet of trains.

In examples, the user interface 224 may be used to receive inputs from users and other systems to make adjustments, for example to change locomotive assignments based on additional information or prior history and experience with respect to a particular locomotive, rail yard, train consist, rail yard, or other portion of the rail system.

The assignment engine 210 may also produce a plurality of commands for each locomotive of the train fleet. In particular, the computer system 202 or a user via inputs into the user interface 224 may provide at least one command for each locomotive of the train fleet based on the generated assignments. Once prepared, each command may be transmitted or communicated to the computing system 202 wherein they are further communicated to the train fleet as a whole.

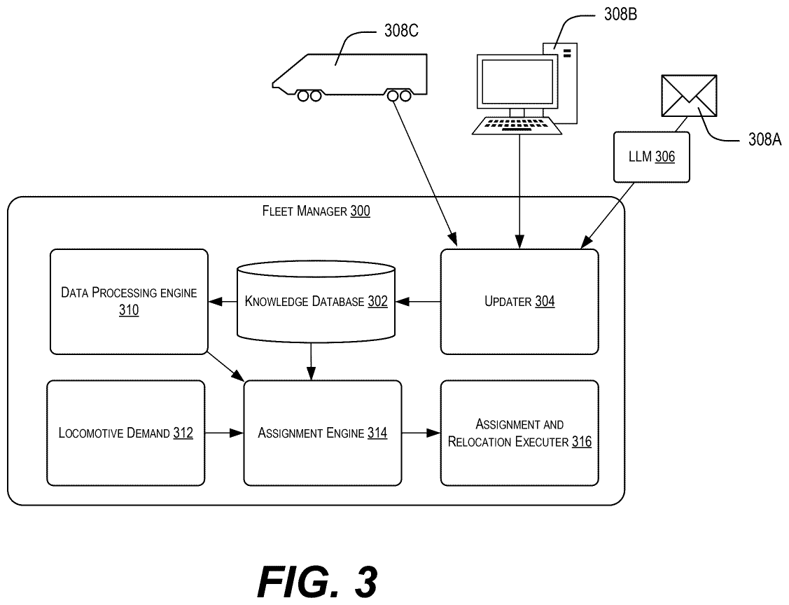

FIG. 3 illustrates a fleet manager 300 used for generating locomotive assignments, in accordance with one or more examples. The fleet manager 300 may be an example of the fleet manager 208 of FIG. 2 and may be implemented on a computing system associated with the railway system, such as a central controller or other such computing system. The fleet manager 300 is configured to receive information, generate rules for determining assignments using one or more engines or modules, and then apply those generated rules to determine and instruct execution of the locomotive assignments. The fleet manager 300 may be used to implement a method as described herein. In particular, the fleet manager 300 includes a knowledge database 302, an updater 304, data processing engine 310, locomotive demand 312, assignment engine 314, and assignment and relocation executer 316.

For example, the fleet manager 300 may receive railroad information related to a railroad system including locomotives within the railroad system and determining railroad data from the railroad information by processing the railroad information, the railroad data associated with schedules, conditions, demand of locomotives, and availability of locomotives. The fleet manager 300 also determines a set of rules for assigning locomotives to trains, locations, and maintenance, the set of rules determined by a machine learning model trained using historical railroad data tagged with locomotive assignment information. The fleet manager 300 further determines assignments for locomotives within the railroad system using the set of rules in response to the railroad data. The fleet manager 300 then outputs the assignments and executing the assignments of the locomotives.

The fleet manager 300 receives raw railroad data from a variety of sources including messages 308A, computing systems 308B, and locomotives 308C. Raw railroad information may be received by the fleet manager 300 relating to the train fleet, railroad, and surrounding environment. In reference to FIG. 3, raw railroad information may be received by the fleet manager 300 and in particular by an updater 304 which may include a data processing engine which, as noted previously, may be configured to consolidate the raw railroad information into a consolidated processed version of the data. In some examples, the data may be pre-processed by an LLM 306 prior to arriving at the updater 304, and/or the updater 304 may include one or more engines for preprocessing data, for example to scrub information from natural language inputs from messages 308A. The data processing engine may incorporate the use algorithms or other inference engines which may draw conclusions or make decision based on a set of rules or data in order to estimate a realistic basis of understanding of resource availability, present and future demand, and the overall status of each component of the train fleet, railway, and surrounding environment. Furthermore, the data processing engine may additionally receive information, in particular argumentative rules or objective information, from the knowledge database 302 to assist in the consolidation of the raw railroad data. As noted previously, knowledge database 302 may include a repository of rules for determining locomotive assignments and may also include an algorithm such as a machine learning model or knowledge-based artificial intelligence agent that may provide rules or facts of the world to assist the updater 304 with consolidating the information.

The updater 304 may be used to process the information and may update or provide one or more additional rules or inputs to the knowledge database 302. The knowledge database 302 may be updated according to information received from the updater 304 and may use the updated information or data to determine locomotive assignments, by the assignment engine 314. The knowledge database may therefore include information relating to the current state of the rail system as well as information related to one or more rules for determining locomotive assignments. In some examples, the updater 304 may process the information to update the knowledge database 302 using an algorithm such as a machine learning model, a neural network, table, linear model, non-linear model, deep neural networks, or other methods known in the art. Further, the algorithm may be generated or refined using one or more techniques known in the art, such as, but not limited to, supervised learning, unsupervised learning, deep learning, reinforcement learning, or evolutionary algorithms.

Still in reference to FIG. 3, the data processing engine 310 may communicate the processed railroad data from the knowledge database 302 to both a user interface and the assignment engine 314. First, the user interface may provide a user with an opportunity to review the processed data via the output device and provide a user input in response. For example, the user may provide additional insight, approve of the computer system's reasoning, disagree with the data, or otherwise comment on the raw data and/or processed data.

In some embodiments, the user provided feedback may be incorporated to update either knowledge database's 302 objective or argumentative knowledge. A user may provide information related to up-to-date status changes, weather changes, or other objective data to the knowledge database 302, such that the knowledge database 302 may alter the processed data in light of the new information. For example, an unexpected change in weather may affect the travel times or available routes which may, subsequently, alter the current condition of the train fleet or railways. Similarly, a user may provide feedback to the argumentative knowledge of the knowledge database 302. For example, the knowledge database 302 may associate a cancellation of an order with an open availability of the train. Through the iterative process of the user providing feedback, the knowledge database 302 may be trained on the cumulative knowledge of the existing users.

Additionally, information regarding locomotive demand 312 may be provided to the assignment engine 314. The locomotive demand 312 may be stored within the knowledge database 302 but may also be based on train schedules across the rail system.

The assignment engine 314 may then be used to determine a plurality of assignments are determined for each of the locomotives of the train fleet. In further detail, the assignment engine 314 may implement the rules and/or information stored in the knowledge database and may also incorporate an algorithm such as a machine learning model, a neural network, table, linear model, non-linear model, deep neural networks, or other methods known in the art. Further, the algorithm may be generated or refined using one or more techniques known in the art, such as, but not limited to, supervised learning, unsupervised learning, deep learning, reinforcement learning, or evolutionary algorithms. Furthermore, in some embodiments, user inputted feedback may be used to train or generate the algorithm. Alternatively, the assignment engine 314 may incorporate a network model, such as a multicommodity space-time network, configured to optimize a flow of resources or commodities through a dynamic network.

The fleet manager 300 may determine a plurality of commands based on the assignments from the assignment engine 314. Still in reference to FIG. 3, the assignment engine 314 may forward the generated assignments to a user interface. The user may view each of the assignments via the output device and interact with an input device to prepare at least one command before each of the locomotives of the train fleet. In particular, each command may include information related to the time of departure, the cargo, the crew, the route, the destination, and the expected time of arrival for each respective locomotive. Furthermore, a plurality of commands may be associated with a single locomotive to instruct a locomotive to accomplish a plurality of assignments. Additionally, in some instances, an existing command may be edited, supplemented, or removed for each locomotive due to changes in the status of the train fleet, the railway, the existing or expected demand, or the surrounding environment. Furthermore, a locomotive may be in the process of completing a previously issued command may be issued an updated or replacement command as a result of the determined assignments. Once the commands for each of the locomotive are determined, the fleet manager 300 may cause the assignments to be carried out by transmitting the prepared commands to the train fleet.

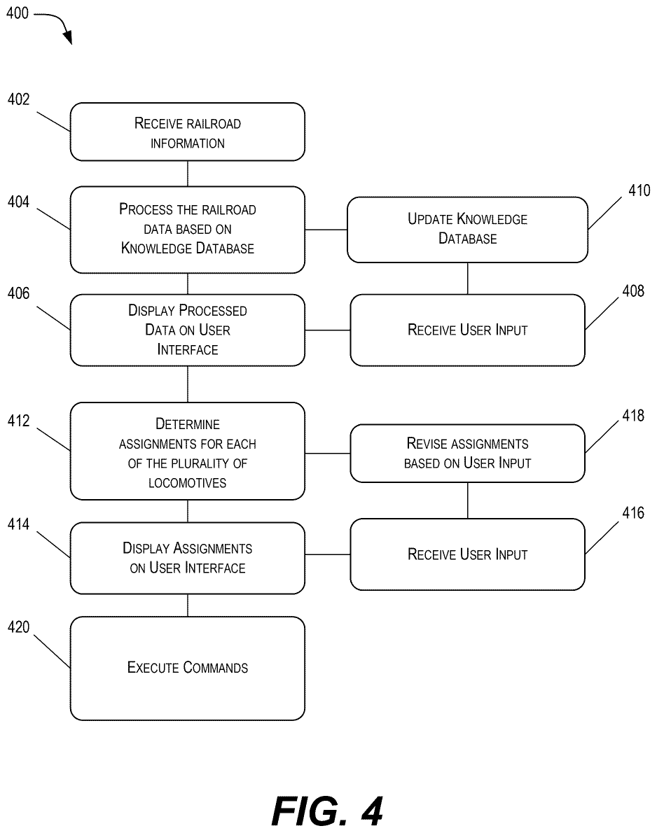

Now in reference to FIG. 4, which illustrates a method 400 for generating locomotive assignments and commands. The method 400 and other processed described herein are illustrated using exemplary flow graphs, each operation of which may represent a sequence of operations that can be implemented in hardware, software, or a combination thereof. In the context of software, the operations represent computer-executable instructions stored on one or more tangible computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

As noted above, the method 400 may be used to prepare commands or assignments for a plurality of locomotives of a train fleet in response to the present demand and future demand of the railroad. To explain further, a user, operator, or assessor, such as a fleet manager may be tasked with reviewing the existing and future demand for locomotives. Therefore, before preparing a command for a locomotive, the landscape of the train fleet, the railway, the personnel, and the environment surrounding the railway may need to be assessed before accurate assignments or commands may be issued to each of the locomotives. As noted previously, the present method may use a manual process where a user may personally consolidate the information to provide an overall status or basis of the railway system. Such a manual process is time intensive and inconsistent.

In some instances, the computer system 202 may be configured to execute the steps of method 400 and, as noted above, FIG. 4 depicts components, structure, and information discussed in the following paragraphs.

The method 400 commences at step 402, where data related to the present status of the railroad, including information related to the train fleet, the railway, the personnel schedule, expected weather, future and present demand and the present locomotive schedule may be communicated to the computer system. In particular, the computer system may be in electronic communication with a central controller which may receive information from either the train fleet itself or from various other sources, sensors, etc.

For instance, the computer system and/or the central controller may receive information from a plurality of sensors that gather information from the train fleet, the railway, and the environment surrounding the train fleet and railway. Data such as locomotive position, locomotive status, present weather, travel times, etc. may be gathered by the sensors. Furthermore, information such as present demand, current crew availability, weather forecast, etc., may be gathered by the central controller and may all be transferred to and received by the computer system. In some instances, once the information described above is collected, the information or data may be transferred between the sensors, computer system and the central controller via a wireless method known in the art such as, but not limited to, WIFI, Bluetooth, cellular networks, or satellite communication. Alternatively, data collected by the train fleet may be transferred in a traditional wired method as well, for example, when an individual train of the train fleet arrives at a destination.

The method 400 continues at step 404, where the raw railroad data received by the computer system may be processed to provide a consolidated basis for the status of the train fleet, the railway, the present demand, and the environment surrounding the train fleet and railway. As mentioned previously, the computer system may incorporate a data processing engine configured to consolidate the received data and may be in electronic communication with a knowledge database. In particular, the knowledge database may additionally include an algorithm and/or set of rules configured to contain a series of argumentative rules and objective information that may assist the data processing engine with consolidated the data received by the computer system.

To further explain, the data processing engine may receive a plurality of information, both present and dynamic from the train fleet, the railway, the central controller, and/or the environment via operator input, sensors, or other methods known in the art. Each of the collected pieces of data, together known as “raw railroad data” may be communicated or forwarded to the data processing engine, wherein the raw railroad data may be consolidated and analyzed in order to prepare a landscape or basis of the railway system. In particular, the data processing engine may incorporate an algorithm such as a machine learning model, a neural network, a table, a linear model, a non-linear model, a deep neural network, or other methods known in the art. In some instances, the algorithm may take the form of an inference engine (or multiple inference engines) which may be used by the computer system and the data processing engine to process the raw information to estimate a realistic basis or cumulative status of resource availability and demand.

As mentioned above, to assist in processing the raw railroad data, the computer system may incorporate or communicate with a knowledge database to process the raw information. To explain further, the knowledge database may be an algorithm such as a machine learning model or knowledge-based artificial intelligence agent. For example, the knowledge database may include structured knowledge such as objective information or argumentative knowledge that may be used to assist in interpreting and consolidating the raw data gathered by the computer system. Furthermore, the objective information may include facts of the world, such as position of the existing train fleet, the status of the railway, the current weather, the expected forecast, etc. The knowledge database may additionally include argumentative knowledge such as rules, instructions, or procedures on how to make assignments for locomotives. For example, the knowledge database may associate poor weather with increased travel times. Alternatively, the knowledge database may take the form of other algorithms known in the art such as, but not limited to, a neural network, a table, a linear model, a non-linear model, a deep neural network, etc. Further, the algorithm may be generated and/or trained using one or more techniques in the art, such as, but not limited to, supervised learning, unsupervised learning, deep learning, reinforcement learning, or evolutionary algorithms.

Furthermore, the knowledge database may additionally be generated or trained based on user provided inputs. In further detail, once the raw railroad data has been consolidated and processed by the computer system, the processed data may be provided to the user via the user interface. As mentioned previously, the user interface may be configured to be included within the computer system or may be a separate component that may be in communication with the computer system. Furthermore, the user interface may include an input device and/or an output device such that information may be displayed to and received by a user, which are each discussed in further detail below in relation to the computer system.

The method 400 continues at step 406, where the consolidated processed data may be displayed to a user via the computer system. As noted above, the computer system may incorporate a user interface which may include an output device configured to present the processed data to a user. Step 406 further includes the user reviewing the processed railroad data and the opportunity for the user to provide feedback. In further detail, the user may review the processed railroad data consolidated by the computer system and provide additional insight, approve of the computer system's reasoning, disagree with the data, or otherwise comment on the raw railroad data and/or processed railroad data In some instances, the user interface described above may further include an input device configured to accept a user's input, such as a microphone, keyboard, touchscreen etc., that may be configured to receive user feedback. In further detail, the output device of the computer system may include a chat-box or other text or voice input application that may be configured such that a user may provide inputs into the computer system using natural language and without a need to learn a new software or input method.

If the user wishes to provide a user input via the user interface, the method 400 may continue on to step 408, however, if the user decides to not provide a user input, the method 400 may continue on to step 412.

In the event a user provides an input into the user interface, the method 400 may continue onto step 408, where the user input is received by the computer system. In some embodiments, to simply the collection of user feedback, a user may provide inputs into the computer system via the user interface using natural language. Such language may be provided via text, speech, or other methods of natural inputs. To interpret the natural language, the computer system may incorporate an algorithm to translate the natural language into structured information the computer system may understand. For example, a natural language processing (NLP) algorithm, such as a large language model (LLM), that are configured to understand a user's natural language. For example, an NLP may be configured to understand the texts to understand the meaning of words and sentences, while also understanding the context of the text to provide additional understanding of the user's intended communication. In other words, the NLP algorithm may transform instructions or feedback given in natural language, via emails, voice recognition, or chat prompts, into structure knowledge that may, ultimately, be provided to the knowledge database. In some instances, the provided natural language may transformed into structured knowledges such as, but not limited to, Boolean login, procedural rules, fuzzy logic, Bayesian logic, neural networks, first-order logic, semantic networks, or other knowledge representation formations. Once the user input is received, the method 400 may continue onto step 410, where the knowledge database may be updated based on the received user inputs.

In further detail, the user provided feedback may be incorporated to update either knowledge database's objective or argumentative knowledge. A user may provide information related to up-to-date status changes, weather changes, or other objective data to the knowledge database, such that the knowledge database may alter the processed data in light of the new information. For example, an unexpected change in weather may affect the travel times or available routes which may, subsequently, alter the current condition of the train fleet or railways. Similarly, a user may provide feedback to the argumentative knowledge of the knowledge database. For example, the knowledge database may associate a cancellation of an order with an open availability of the train.

Through the iterative process of the user providing feedback, the knowledge database may be trained on the cumulative knowledge of the existing users. Subsequently, the knowledge database may provide objective information and argumentative rules to assist the data processing engine in consolidating the raw railroad data to be more consistent with the knowledge and understanding of the user, while reducing the amount of time that it would take a user to manually consolidate the raw data. Furthermore, by providing the user an option to input natural language feedback and comments, the use of an NLP algorithm simplifies a user's review process of the consolidated processed data. In other words, the use of a NLP algorithm to interpret a user's feedback does not require the user to learn a new system or interface and, subsequently, reduces the barrier for collecting new information to train both the objective information and argumentative knowledge of the knowledge database.

Once the knowledge database has been updated or iterated due to the received user input, the method 400 may continue back to step 404, wherein the raw railroad data may be reprocessed in light of the updated knowledge database. In some instances, the processed data may be reformulated or reprocessed in response to the input in order to provide an updated consolidation of the raw railroad data. The reprocessed data may then be provided to the user via the output device and, subsequently, may be reviewed by the user again.

Once the processed or reprocessed data has been approved or accepted, the method 400 may continue to step 412, where an assignment for each locomotive of the train fleet may be determined. In particular, the computer system may further include a data optimization engine which may be configured to autonomously or semi-autonomously determine a plurality of assignments for each of the locomotives in the train fleet. For example, each locomotive of the train fleet may be given an assignment associated with an existing demand, wherein the assignment may include information such as a destination, an arrival time, a departure time, an estimated travel time, a route, a cargo load, and a crew. Furthermore, in some instances, each assignment may extend further than a singular trip. For example, a locomotive may be assigned a first assignment, a second assignment, a third assignment, etc. For example, in some application, demand may indicate that cargo may regularly travel from a central area of the country out towards the coasts at a much greater quantity than cargo goes from the coasts towards the center. Therefore, it may be desirable, the include a first assignment to carry cargo outwards towards the coasts and a second assignment to return back towards the center of the country with a reduced cargo load.

As noted briefly above, the computer system may incorporate a data optimization engine which may be configured to evaluate the processed data to prepare each locomotive a command or assignment. In some instances, the data optimization engine may incorporate an algorithm such as a machine learning model, a neural network, table, a linear model, a non-linear model, a deep neural network, or other methods known in the art. Further, the algorithm may be generated or refined using one or more techniques known in the art, such as, but not limited to, supervised learning, unsupervised learning, deep learning, reinforcement learning, or evolutionary algorithms. Furthermore, in some embodiments, user inputted feedback may be used to train or generate the algorithm. Alternatively, the data optimization engine may incorporate a network model, such as a multicommodity space-time network, configured to optimize a flow of resources or commodities through a dynamic network.

Furthermore, the data optimization engine may be configured to autonomously or semi-autonomously assess existing assignments to review, amend, or cancel the assignments. In further detail, in some embodiments, a locomotive command or assignment from a previous day or time period may be re-evaluated in light of the updated information collected by the computer system in regard to the train fleet, railway data, and environment data. For example, a locomotive may be scheduled to take a first route to a location, however, upon review of the railway, it is shown that a particular stretch of railway may be undergoing unexpected maintenance and, therefore, is closed. In such an instance, the computer system may amend, cancel, or issue new assignments in light of the new information.

Once each of the assignments for each locomotive is determined, the method 400 may continue onto step 414, where each of the assignments may be presented to the user via the user interface. Similar to step 406 describe above, the computer system may incorporate a user interface which may include an output device which may be configured to display each of the assignments. Step 414 may further include the user reviewing the assignments and providing an opportunity for the user to provide feedback in the form of user input via an input device of the user interface.

If the user wishes to provide an input via the user interface relative to step, the method 400 may continue on to step 416, however, if the user decides to not provide feedback the method 400 may continue on to step 420.

In the event a user provides a user input into the user interface, the method 400 may continue onto step 416, where the user input is received by the computer system. In some instances, the user may provide feedback in the form of natural language, wherein the NLP algorithm may again translate the input into a form that may be understood by the computer system and then used to train or generate a new or updated version of the optimization engine.

Once the user input is received, the method 400 may continue onto step 418, where data optimization engine may be updated based on the received user inputs from step 416. In further detail the data optimization engine may incorporate an algorithm, such as a machine learning model, configured to determine the assignments of each locomotive of the train fleet based on the consolidated or processed railroad data. To further increase the efficacy and accuracy of the algorithm of the data optimization engine, the user inputs associated with step 416 may be used to train the model or algorithm of the data optimization engine using methods known in the art such as reinforcement learning, active learning, semi-supervised learning, etc. Through the iterative process of receiving user feedback, the data optimization engine may be trained using the knowledge of each of the users, resulting in a more efficient data optimization engine. Alternatively, the optimize engine may incorporate a network model, such as a multicommodity space-time network, configured to optimize a flow of resources or commodities through a dynamic network.

Once the data optimization engine has been updated or iterated due to the received user input, the method 400 may continue back to step 412, wherein assignments for each of the locomotives of the train fleet may redetermined with the updated data optimization engine. In such an instance, the assignments may then be redisplayed to the user via the output device and reviewed again by the user.

Once the assignments for each of the locomotives of the train fleet are viewed and reviewed, the method 400 may continue to step 420 where the user may determine a plurality of commands associated with the assignments for each of the locomotives of the train fleet. In particular, each command may include information related to the time of departure, the cargo, the crew, the route, the destination, and the expected time of arrival for each respective locomotive. Furthermore, a plurality of commands may be associated with a single locomotive to instruct a locomotive to accomplish a plurality of assignments. Additionally, in some instances, an existing command may be edited, supplemented, or removed for each locomotive due to changes in the status of the train fleet, the railway, the existing or expected demand, or the surrounding environment. Furthermore, a locomotive may be in the process of completing a previously prepared command and may be given an updated or replacement command as a result of the assignments.

Once the commands for each locomotive of the train fleet have been generated, the method 400 may continue to transmit to the train fleet. In particular, the computer system may be further configured to transmit the plurality of commands back to the central controller and, subsequently, to each locomotive of the train fleet. The computer system may communicate each command to the central controller which may then be communicated to each individual locomotive of the train fleet using methods known in the art such as, but not limited to a wireless method known in the art such as, but not limited to, WIFI, Bluetooth, cellular networks, or satellite communication. In some embodiments, the computer system may further include a monitoring engine configured to assist the user in monitoring the execution of the produced commands by providing the user with information related to the present status of each locomotive.

Furthermore, in some instances, the computer system may further include a monitoring engine configured to assist the user in monitoring the execution of the produced commands by providing the user with information related to the present status of each locomotive.

The description herein is directed towards systems and methods for producing commands or assignments for a plurality of locomotives of a train fleet. In particular, the methods and system discussed herein may be focused on increasing the efficiency, accuracy, and consistency of producing commands or assignments across a plurality of locomotive across a plurality of dynamic railways.

FIG. 5 depicts a component level view of the computer system 500 for use with the systems and methods described herein, in accordance with various examples of the presently disclosed subject matter. The computer system 500 could be any device capable of providing the functionality associated with the systems and methods described herein. The computer system 500 can include several components to execute the above-mentioned functions. The computer system 500 may be comprised of hardware, software, or various combinations thereof. As discussed below, the computer system 500 can comprise memory 502 including an operating system (OS) 504 and one or more standard applications 506. The standard applications 506 may include applications that may accept user inputs, such as a chat-box, or modify, edit, create, or delete data associated with the data or data sets related to the execution of the methods described herein.

In some embodiments, it is envisioned that a plurality of computer systems 500 may be used to execute the methods described herein, accept the inputs, and display the outputs. Furthermore, each of these plurality of computer systems 500 may be configured to be in communication via components and structures described herein. However, it is additionally envisioned that a singular computer system may be used to execute the methods and functions described herein.

The computer system 500 can also include one or more processor(s) 514 and one or more of removable storage 516, non-removable storage 518, output device(s) 520, and input device(s) 522. In various implementations, the memory 502 can be volatile (such as random-access memory (RAM)), non-volatile (such as read only memory (ROM), flash memory, etc.), or some combination of the two. Furthermore, the memory 502 may include various other pieces of information such as, the raw railroad data 508, the processed railroad data 510, the assignments 512, or other information that may be generated, received, or produced during the execution of methods described herein.

The memory 502 can also include the OS 504. The OS 504 varies depending on the manufacturer of the computer system 500. The OS 504 contains the modules and software that support basic functions of the computer system 500, such as scheduling tasks, executing applications, and controlling peripherals. The OS 504 can also enable the computer system 500 to send and retrieve other data and perform other functions, such as communicating, receiving, or parsing the raw railroad data 508, the processed railroad data 510, the assignments 512, or other information that may be generated, received, or produced during the execution of methods described herein.

The computer system 500 can also comprise one or more processor(s) 514. In some implementations, the processor(s) 514 can be one or more central processing units (CPUs), graphics processing units (GPUs), both CPU and GPU, or any other combinations and numbers of processing units. The computer system 500 may also include additional data storage devices (removable and/or non-removable) such as, for example, magnetic disks, optical disks, or tape. Such additional storage is illustrated in FIG. 5 by removable storage 516 and non-removable storage 518. In some instances, the processor(s) 514 may be configured to execute the functions of the data processing engine 524, the data optimization engine 526, and/or the monitoring engine 528.

Non-transitory computer-readable media may include volatile and nonvolatile, removable and non-removable tangible, physical media implemented in technology for storage of information, such as computer readable instructions, data structures, program modules, or other data. The memory 502, removable storage 516, and non-removable storage 518 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information, which can be accessed by the computer system 500. Any such non-transitory computer-readable media may be part of the computer system 500 or may be a separate database, databank, remote server, or cloud-based server.

In some implementations and as discussed above, the output device(s) 522 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 522 can also include speakers, or similar devices, to play sounds or ringtones when an audio call or video call is received. Output device(s) 522 can also include ports for one or more peripheral devices, such as headphones, peripheral speakers, or a peripheral display.

In various implementations, input device(s) 522 include any input devices known in the art. For example, the input device(s) 522 may include a camera, a microphone, or a keyboard/keypad. The input device(s) 522 can include a touch-sensitive display or a keyboard to enable users to enter data and make requests and receive responses via web applications (e.g., in a web browser), make audio and video calls, and use the standard applications 506, among other things. A touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device(s) 522 and an output device(s) 520. Additionally, and as mentioned above, the input device(s) 522 and the output device(s) 520 may be combined into a graphical user interface which may be used to execute the methods described herein.

### INDUSTRIAL APPLICABILITY

The present disclosure relates generally to method and systems for determining a basis of the overall status of a railway and train fleet, while also determining assignments for the locomotives of the train fleet. Due to the complexity and number of factors that may be encountered while execution operations of a railway, an overall basis or status of the railway and the train fleet must be created for accurate assignments for each locomotive of the train fleet such that train downtime and delays are minimized, decreasing costs associated with delays of trains. The current process of consolidating the railroad information may be an arduous and time-consuming process due to the large number of dynamic factors. For example, reviewing the information related to the train fleet and the environment to create an up-to-date landscape of the status of the train fleet and demand may take into account present data such as the position of each locomotive, the availability of each locomotive, existing scheduling and demands of each locomotive, the status of each locomotive (i.e., under repair) and the availability of crew. Furthermore, a review of the information may take into account dynamic information that is more unpredictable, such as running times between legs of track or railyards, changing train schedules, changing crew availability, delays related to unexpected stops or repairs, inclement weather, or a change in the overall demand of the train fleet due to the addition, amendment, or cancellation of orders.

In order to efficiently consolidate the various pieces of information and produce an adapting model that takes into account the current conditions as well as user-provided inputs and other data sources, a computer system may be configured to receive and consolidate raw railroad information to create an overall status or basis of the railroad itself. In particular, the computer system may use a combination of a data processing engine and a knowledge database to combine the various pieces of railroad information efficiently and consistently and use the information contained therein to generate rules for determining locomotive assignments. The knowledge database, in some instances, may be used by a computer model such as an algorithm which may collect, learn from, and recall knowledge submitted to the knowledge database. In other words, the knowledge database may receive user feedback from experienced operators or assessors to maintain objective information and argumentative knowledge in respect to the process of consolidating and processing the large amount of data that may be received.

In some instances, the process of collecting the user feedback may be simplified by incorporating a natural language processing (NLP) algorithm, for example a large language model, such that a user may provide feedback using natural language. The NLP algorithm may translate or convert the natural language inputs of the user into structured information or knowledge which the computer system or the knowledge database may be able to understand. As feedback is provided, the knowledge database may begin to collect the combined knowledge of each of the users such that the combination of the data processing engine and the knowledge database may efficiently and consistently consolidate the large amount of data that may be received by the computer system.

Subsequently, the consolidated basis of the railway may then be reviewed by the computer system, more specifically the data optimization engine, to determine or generate a plurality of assignments for each of the locomotives. Similarly, the present method uses a set of generated rules to generate each of the assignments, preventing and overcoming complications involved with a laborious review of the basis or status of the railway before a user may prepare assignments which may meet the current and expected demands. In some instances, the data optimization engine may incorporate an algorithm that may automatically or semi-automatically review the basis of the railway. In some instances, the data optimization engine may incorporate natural language user feedback to further train or generate the algorithm such that the optimization engine may learn from each of the users to provide a more consistent and efficient process in comparison to the present manual process.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed:

1. A system for determining locomotive assignments, the system comprising:
a processor; and
a non-transitory computer readable medium that stores instructions that when executed by the processor causes the processor to perform operations comprising:
receiving railroad information related to a railroad system including locomotives within the railroad system;
determining railroad data from the railroad information by processing the railroad information, the railroad data associated with schedules, conditions, demand of locomotives, and availability of locomotives;
determining a set of rules for assigning locomotives to trains, locations, and maintenance, the set of rules determined by a machine learning model trained using historical railroad data tagged with locomotive assignment information;
determining assignments for locomotives within the railroad system using the set of rules in response to the railroad data; and
outputting the assignments and executing the assignments of the locomotives.

2. The system of claim 1, wherein outputting the assignments and executing the assignments comprises:
preparing at least one command for at least one locomotive, wherein the command is based on the assignments; and
transmitting the at least one command to a railyard associated with the at least one locomotive.

3. The system of claim 1, wherein receiving the railroad information comprises accessing one or more messages conveyed by computing devices of the railroad system and determining the railroad data further comprises processing the messages using a large language model.

4. The system of claim 1, wherein the operations further include:
displaying the assignments on an output device;
receiving an indication inputted into an input device by a user, the indication associated with an adjustment to one or more of the assignments;
determining one or more additional rules using the machine learning model; and
determining a second set of assignments using the set of rules and the one or more additional rules.

5. The system of claim 1, wherein the railroad information comprises:
information related to a position and status of the locomotives;
information related to a condition of the railroad system; and
information related to a demand for locomotives within the railroad system.

6. The system of claim 1, wherein the set of rules describe conditions for locomotive assignments and determining the assignments comprises applying the set of rules to the railroad data.

7. The system of claim 1, wherein the railroad information further comprises locomotive maintenance schedules for locomotives in the railroad system.

8. A computer-implemented method for determining locomotive assignments, the method comprising:
receiving railroad information related to a railroad system including locomotives within the railroad system;
determining railroad data from the railroad information by processing the railroad information, the railroad data associated with schedules, conditions, demand of locomotives, and availability of locomotives;
determining a set of rules for assigning locomotives to trains, locations, and maintenance, the set of rules determined by a machine learning model trained using historical railroad data tagged with locomotive assignment information;
determining assignments for locomotives within the railroad system using the set of rules in response to the railroad data; and
outputting the assignments and executing the assignments of the locomotives.

9. The computer-implemented method of claim 8, wherein determining the assignments comprises using a second machine learning model configured to produce the assignments in response to the railroad data and the set of rules, wherein the second machine learning model is trained using historical locomotive assignment data, historical rule data, and one or more evaluation parameters.

10. The computer-implemented method of claim 8, further comprising:
receiving one or more additional conditions for assigning the locomotives; and
determining, using the machine learning model, a second set of rules based on inputs of the set of rules and the one or more additional conditions.

11. The computer-implemented method of claim 8, wherein outputting the assignments and executing the assignments comprises:
preparing at least one command for at least one locomotive, wherein the command is based on the assignments; and
transmitting the at least one command to a railyard associated with the at least one locomotive.

12. The computer-implemented method of claim 8, further comprising:
displaying the assignments on an output device;
receiving an indication inputted into an input device by a user, the indication associated with an adjustment to one or more of the assignments;
determining one or more additional rules using the machine learning model; and
determining a second set of assignments using the set of rules and the one or more additional rules.

13. The computer-implemented method of claim 8, wherein the set of rules describe conditions for locomotive assignments and determining the assignments comprises applying the set of rules to the railroad data.

14. The computer-implemented method of claim 8, further comprising accessing a set of conditions, the set of conditions describing natural language inputs associated with locomotive assignments, wherein the set of rules are further provided to the machine learning model as inputs.

15. A method for determining locomotive assignments, the method comprising:
receiving, at a computing device of a fleet management system, railroad information related to a railroad system including locomotives within the railroad system;
determining, by the computing device, railroad data from the railroad information by processing the railroad information, the railroad data associated with schedules, conditions, demand of locomotives, and availability of locomotives;
determining, by the computing device, a set of rules for assigning locomotives to trains, locations, and maintenance, the set of rules determined by a machine learning model trained using historical railroad data tagged with locomotive assignment information;
determining, by the computing device, assignments for locomotives within the railroad system using the set of rules in response to the railroad data; and
outputting the assignments and executing the assignments of the locomotives.

16. The method of claim 15, wherein the method further includes:
preparing at least one command for at least one locomotive, wherein the command is based on the assignments; and
transmitting the at least one command to the at least one locomotive.

17. The method of claim 15, wherein determining the assignments comprises using a second machine learning model configured to produce the assignments in response to the railroad data and the set of rules, wherein the second machine learning model is trained using historical locomotive assignment data, historical rule data, and one or more evaluation parameters.

18. The method of claim 15, further comprising:
receiving one or more additional conditions for assigning the locomotives; and
determining, using the machine learning model, a second set of rules based on inputs of the set of rules and the one or more additional conditions.

19. The method of claim 15, further comprising:
displaying the assignments on an output device;
receiving an indication inputted into an input device by a user, the indication associated with an adjustment to one or more of the assignments;
determining one or more additional rules using the machine learning model; and
determining a second set of assignments using the set of rules and the one or more additional rules.

20. The method of claim 15, further comprising accessing a set of conditions, the set of conditions describing natural language inputs associated with locomotive assignments, wherein the set of rules are further provided to the machine learning model as inputs.
